(19) United States
(12) Patent Application Publication
(10) Pub. No.: US 2026/0365309 A1
(43) Pub. Date: Nov. 19, 2026

(54) CANOPY ATTACHMENT ASSEMBLY

(71) Applicant: BAE SYSTEMS PLC, LONDON (GB)

(72) Inventors: Hamish CHANDLER, Oxford, Oxfordshire (GB); Mengyizhe HE, Oxford, Oxfordshire (GB)

(73) Assignee: BAE SYSTEMS PLC, LONDON (GB)

(21) Appl. No.: 19/477,400

(22) PCT Filed: Apr. 19, 2024
(86) PCT No.: PCT/GB2024/051030

§ 371 Date: Oct. 21, 2025

(30) Foreign Application Priority Data
Apr. 21, 2023 (GB) 2305903.3

(51) Int. Cl. B64D 17/38; B64C 31/036; B64D 17/80

(52) U.S. Cl. CPC B64D 17/38; B64C 31/036; B64D 17/80

(57) ABSTRACT

A canopy attachment assembly comprising at least one yoke, wherein the at least one yoke comprises at least two connection points; a canopy line system, configured to be securable to the at least one yoke in use via at least two connectors, wherein each of the at least two connectors is configured to fit exclusively into a predetermined one of the at least two connection points in the at least one yoke, such that the canopy line system is securable to the at least one yoke in one orientation only.

### FIELD

The present invention relates to a canopy attachment assembly. More specifically, the present invention relates to a canopy attachment assembly, a canopy arrangement, and a paramotor.

### BACKGROUND

Paramotors, also known as motorised parachutes or powered paragliders, are powered air vehicles with a canopy or parachute used as the wing. Applications of a paramotor include sporting/leisure activities, payload delivery, aerial photography and traffic monitoring. The vehicle may be flown by a pilot or unmanned, using a flight control system and/or through remote control by an operator.

Conventional paramotors have a canopy with a plurality of canopy lines, each attached at one end to a respective point on the canopy, and attached at the other end to at least one connection point on the vehicle. The canopy is then able to pivot about this at least one connection point. To ensure a stable aerial vehicle, there may be at least two connection points on the vehicle, spaced apart from each other in a direction substantially perpendicular to the longitudinal axis of the vehicle. All the canopy lines attached to the left side of the canopy may be secured to the left connection point in use, and all the canopy lines attached to the right side of the canopy may be secured to the right connection point in use.

A significant problem arises when a technician assembles the paramotor or changes the canopy, for example for repair or to replace it with a canopy of different size. The technician is usually a different person to the pilot, resulting in the technician having minimal understanding of the correct setup of the paramotor. Human error may cause the technician to attach the canopy lines to the wrong one of the at least two connection points on the vehicle. This may cause the canopy lines to get tangled up and/or the canopy may be assembled in the wrong orientation. A canopy that has been assembled 180 degrees in the wrong orientation results in a reverse aerofoil which is unable to generate lift and therefore would not work.

The present invention provides a canopy attachment assembly that seeks to reduce or prevent human error when attaching a canopy to a vehicle.

### BRIEF DESCRIPTION OF THE INVENTION

Accordingly, the present invention provides a canopy attachment assembly comprising:

at least one yoke, wherein the at least one yoke comprises at least two connection points;

a canopy line system, configured to be securable to the at least one yoke in use via at least two connectors, wherein each of the at least two connectors is configured to fit exclusively into a predetermined one of the at least two connection points in the at least one yoke, such that the canopy line system is securable to the at least one yoke in one orientation only.

In at least one embodiment, the at least two connection points and the at least two connectors are configured in size such that each of the at least two connectors fit exclusively into a predetermined one of the at least two connection points in the at least one yoke.

In at least one embodiment, each of the at least two connection points comprises a bore in the at least one yoke.

In at least one embodiment, each of the at least two connectors comprises a D-shaped shackle.

In at least one embodiment, each D-shaped shackle comprises a looped body and a load pin, the looped body comprising two opposing ends, wherein each opposing end comprises an aperture such that the load pin is securable through both apertures in use to form a closed loop.

In at least one embodiment, the diameter of each bore is proportional in size to the thickness of the looped body of the D-shaped shackle that fits exclusively into said predetermined bore.

In at least one embodiment, the thickness of the load pin of each D-shaped shackle is proportional in size to the diameter of the predetermined one of the at least two bores that said D-shaped shackle fits exclusively into.

In at least one embodiment, each of the at least two connection points further comprises a bushing with a flange at each end, wherein each bushing is configured to fit exclusively into a predetermined one of the at least two bores in the at least one yoke.

In at least one embodiment, the distance between the two opposing ends of the looped body of each D-shaped shackle is proportional to the length of the bushing that said D-shaped shackle fits exclusively into, such that each flange of each bushing is configured to sit substantially flush with one of the two opposing ends of the looped body of said D-shaped shackle.

In at least one embodiment, each of the at least two connection points further comprises a first boss and a second boss, the first boss configured to extend outward from a first side of each bore in the at least one yoke and the second boss configured to extend outward from a second side of each bore in the at least one yoke in the opposite direction to the first boss, the distance the first and second bosses are configured to extend outward from the at least one yoke proportional to the length of the bushing that fits exclusively into said bore.

In at least one embodiment, the at least two connection points and the at least two connectors are both configured in shape such that each of the at least two connectors fit exclusively into a predetermined one of the at least two connection points in the at least one yoke.

In at least one embodiment, the at least two connection points comprise a first connection point and a second connection point, wherein the first connection point comprises a square hole in the at least one yoke, and the second connection point comprises a round hole in the at least one yoke.

In at least one embodiment, the at least two connectors comprise a first connector and a second connector, wherein the first connector comprises a square cross-section to fit exclusively into the first connection point, and the second connector comprises a circular cross-section to fit exclusively into the second connection point.

In at least one embodiment, the at least two connection points are positioned on the at least one yoke such that each of the at least two connectors fit exclusively into a predetermined one of the at least two connection points in the at least one yoke.

In at least one embodiment, the at least one yoke comprises a primary plate, the plane of the primary plate being vertically arranged in use.

In at least one embodiment, the at least two connection points are located proximate a top edge of the primary plate of the at least one yoke in use.

In at least one embodiment, the distance between the centre of each bore and the top edge of the primary plate of the at least one yoke in use is proportional to the thickness of the looped body of the D-shaped shackle that fits exclusively into said predetermined bore.

In at least one embodiment, the height of the looped body of each D-shaped shackle is configured in size such that said D-shaped shackle fits exclusively into a predetermined one of the at least two connection points in the at least one yoke.

In at least one embodiment, the primary plate of the at least one yoke comprises at least three connection points, the at least three connection points all being substantially collinear. In at least one embodiment, the at least one yoke further comprises a secondary plate arranged perpendicular to the primary plate.

In at least one embodiment, the secondary plate comprises at least two connection points located along a top edge of the secondary plate in use, the plane of the secondary plate being vertically arranged in use.

In at least one embodiment, there is provided a canopy arrangement comprising:

a canopy attachment assembly according to the invention; and a vehicle, wherein the at least one yoke is configured to be pivotably securable to the vehicle in use.

In at least one embodiment, the at least one yoke is configured to be pivotably securable to the vehicle in use by a mounting bolt.

In at least one embodiment, the mounting bolt comprises a body with a first end and a second end, the first end having a larger diameter than the second end, such that the mounting bolt is configured to secure the at least one yoke to the vehicle in one orientation only.

In at least one embodiment, the vehicle comprises a first and a second opposing arm, the first opposing arm configured to extend across a first side of the primary plate of the at least one yoke and the second opposing arm configured to extend across a second side of the primary plate of the at least one yoke, wherein a hole is configured to align through each of the opposing arms and the primary plate, the hole through the at least one yoke comprising a first and second boss, the first boss configured to extend outward from a first side of the hole and the second boss configured to extend outward from a second side of the hole in the opposite direction to the first boss, the first boss configured to have a larger diameter than the second boss, such that the mounting bolt is configured to fit through each hole in one orientation only.

In at least one embodiment, the at least one yoke comprises at least one sensor.

In at least one embodiment, the at least one sensor comprises at least one of:
a non-contact angular position sensor configured to monitor the angle of the at least one yoke with respect to the vehicle; and
a load sensor configured to monitor a lift force exerted on the at least one yoke.

In at least one embodiment, there is provided a paramotor comprising a canopy attachment assembly according to the invention.

### BRIEF DESCRIPTION OF THE FIGURES

In order that the present disclosure may be more readily understood, preferable embodiments thereof will now be described, by way of example only, with reference to the accompanying drawings, in which:

FIG. 1 schematically illustrates a paramotor incorporating a canopy attachment assembly embodying the present invention.

FIG. 2 schematically illustrates the primary plate of the yoke in use.

FIG. 3 illustrates an enlarged view of the yoke with the at least two connection points inserted into it. The yoke has been made transparent so that the otherwise unseen bushings may be seen.

FIG. 4 illustrates an enlarged view of the yoke with the at least two connection points inserted into it; and

FIG. 5 schematically illustrates the mounting bolt, according to at least one embodiment.

### DETAILED DESCRIPTION OF THE DISCLOSURE

Embodiments of the present invention provide for a canopy attachment assembly configured to reduce or prevent human error when attaching a canopy to a vehicle.

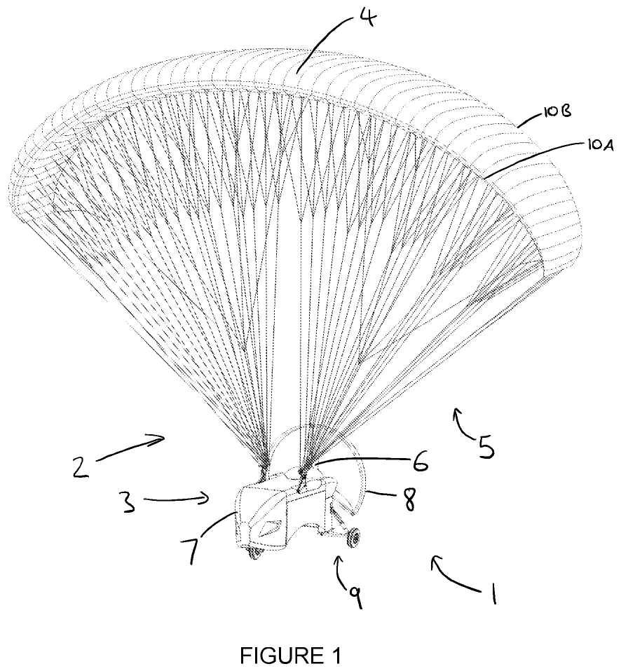

Referring to FIG. 1, a canopy arrangement 1 may comprise a canopy attachment assembly 2 and a vehicle 3. The canopy attachment assembly 2 may comprise a canopy 4, a canopy line system 5, and at least one yoke 6. The embodiment shown in FIG. 1 comprises two yokes 6. In at least one embodiment, the vehicle 3 is an aerial vehicle. A paramotor may comprise the canopy attachment assembly.

The canopy 4 acts as a soft wing for the vehicle. It comprises an aerofoil cross section to generate lift. The canopy 4 may be made of fabric so that it can be easily manipulated when steering/braking/accelerating.

The vehicle 3 may comprise an airframe 7, a propulsion unit 8, an undercarriage 9 and a pilot and/or flight control system.

To suspend the vehicle 3, the canopy 4 may have a plurality of canopy lines 5 secured between several respective points on the canopy 4 and the vehicle 3, as in conventional constructions. The canopy lines 5 are configured to control the movement of the canopy 4. The canopy lines 5 may be attached directly to the vehicle 3, or via a yoke 6 pivotably securable to the vehicle 3. Risers may be used to group two or more of the canopy lines 5 together to make it easier to attach to the vehicle 3 or yoke 6. The orientation of the yoke 6 relative to the vehicle 3 is used to control the canopy 4 by generating restoring forces to counteract any misalignment of the canopy 4 relative to the vehicle 3, especially during take-off.

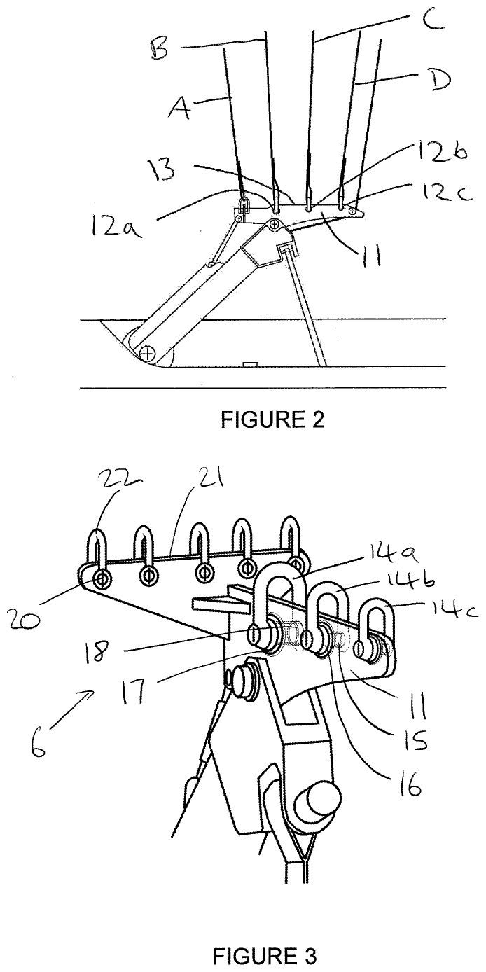

In at least one embodiment, the canopy lines 5 may be distributed across the yoke 6 such that the canopy lines 5 attached closest to the leading edge 10A of the canopy 4—the A lines-may be connected at the front of the yoke in use, while the canopy lines attached closest to the trailing edge 10B—the B, C or D lines—may be connected further back on the yoke in use. The B lines (and similarly the C or D lines) may all be connected at the same point on the yoke, or at at least two different points across the yoke. The A, B, C and D lines have been indicated in FIG. 2. There may also be brake lines attached to the yoke or directly to the vehicle. The brake lines are usually attached to the canopy proximate the trailing edge. FIG. 1 illustrates a canopy line arrangement, where a given line may branch out into at least two lines, such that the lines can attach to the canopy at at least two different points.

In at least one embodiment, and as seen in FIG. 1, the canopy attachment assembly 2 may comprise two yokes 6. The A, B, C and D lines attached to the left side of the canopy 4 may be secured to the one of the two yokes 6 that is positioned towards the left side of the canopy arrangement 1 in use, and the A, B, C and D lines attached to the right side of the canopy 4 may be secured to the other one of the two yokes 6 that is positioned towards the right side of the canopy arrangement 1 in use. The two yokes 6 may each be arranged at an angle to the longitudinal axis of the vehicle 3 such that the back of the two yokes 6 in use are angled towards each other. As a result, the distance between the A lines secured to each of the yokes 6 may be different to the distance between the B, C and/or D lines secured to each of the yokes 6. The variation in these distances can affect the inflation of the wing during take-off, as a given load exerted on the A lines will manipulate the canopy differently to said load exerted on the B, C or D lines.

In FIG. 2, the yoke 6 comprises a primary plate 11, wherein the plane of said primary plate 11 is vertically arranged in use. In this disclosure, a plate may be defined as a substantially planar object. The primary plate 11 may be substantially elongate.

In at least one embodiment, the yoke 6 may comprise at least two connection points 12 (referenced separately as 12a, 12b and 12c in FIG. 2) for the canopy lines 5 and/or risers to be removably attached to the yoke 6. The at least two connection points 12 may be located proximate a top edge 13 of the primary plate 11 of the yoke 6 in use. Although two connection points 12 may be used, the preferred embodiment is that the primary plate 11 of the yoke 6 comprises at least three connection points 12. FIG. 2 shows three connection points 12a, 12b, 12c located proximate a top edge 13 of the primary plate 11 of the yoke 6 in use. These three connection points 12a, 12b, 12c may be spaced apart from each other in a direction substantially parallel to the longitudinal axis of the vehicle 3, although this is not essential. The B lines may be attached to the connection point 12a closest to the front of the primary plate 11 in use, the C lines may be attached to the middle connection point 12b, and the D lines may be attached to the connection point 12c furthest from the front of the primary plate 11 in use. The three connection points 12a, 12b, 12c may all be substantially colinear.

The canopy lines 5 may be removed from the yoke 6/vehicle 3 for ease of storage of the canopy 4, or to change the size of the canopy 4 based on its intended application. As the technician may often be different to pilot, the technician may have minimal understanding of how to correctly attach the canopy lines 5 to the yoke 6. Human error may cause the canopy 4 to be assembled in the wrong orientation. For example, referring to FIG. 2, if the B lines are attached at the connection point 12c proximate the back of the yoke 6 in use, and the D lines are attached at connection point 12a proximate the front of the yoke 6 in use, the canopy 4 is rotated 180 degrees away from its correct orientation. This results in a canopy 4 with a reverse aerofoil which simply would not work. The canopy lines 5 may also get tangled up, making it more difficult to control the canopy 4.

The canopy line system 5 may be configured to be securable to the yoke 6 in use via at least two connectors 14. FIG. 3 shows the preferred embodiment which has three connectors. The three connectors 14 may be configured to fit exclusively into a predetermined one of two connection points 12 in the yoke 6, such that the canopy line system 5 may be securable to the yoke 6 in one orientation only. In other words, it is not possible to fit a given connector 14 into any but the correct connection point 12. The canopy attachment assembly 2 seeks to reduce or prevent human error when attaching the canopy 4 to the yoke 6, as correct assembly requires little or no prior knowledge of the setup.

In at least one embodiment, the at least two connection points 12 and the at least two connectors 14 may be configured in size such that each of the at least two connectors 14 fit exclusively into a predetermined one of the at least two connection points 12 in the yoke 6. Each connector 14 can only be fit into a certain (predetermined) connection point 12, thereby preventing any human error on assembly.

The at least two connection points 12 may each comprise a bore 12 through the yoke 6. In at least one embodiment, this bore 12 may be circular. It may otherwise be square, triangular, etc.

The at least two connectors 14 may each comprise a D-shaped shackle 14. The D-shaped shackle 14 may comprise a looped body with two straight end sections substantially parallel to one another and a curved middle section joining the two straight end sections to make a “U” shape. The canopy lines 5 and/or risers may be looped through or otherwise secured to the looped body. The looped body further comprises two opposing ends each having an aperture. Each D-shaped shackle 14 also comprises a load pin. The load pin may be partially or fully threaded. Another type of securing mechanism may be used such as a bolt or clevis-type pin.

The first of the two opposing ends of each looped body extends across a first side of the yoke 6 to align with one of the at least two bores 12 on a first side, and the second of the two opposing ends extends across a second side of the yoke 6 to align with said one of the at least two bores 12 on a second side. The load pin may be configured to be securable through both apertures in the opposing ends and said one of the at least two bores 12 to form a closed D-shaped loop. This then secures the canopy lines 5 and/or risers inside the closed loop, providing a robust connection between the canopy 4 and the vehicle 3. The load pin configuration also provides a simple way to disconnect the canopy lines 5 from the yoke 6.

D-shaped shackles 12 may be used to join the canopy lines 5 to the vehicle 3 via in-line tension. The two straight members of the looped body ensure that the canopy lines 5 may only be looped around the curved member of the looped body, thereby only allowing tension to be exerted in a direction substantially parallel to the two straight members. The curved member ensures that all of the canopy lines 5 attached to a given D-shaped shackle 12 are centralised, such that they line up with each other along the centre line of the looped body when in tension.

On the other hand, bow shackles, also known as anchor shackles, comprise an entirely curved looped body, without any straight members. Bow shackles may be used instead of D-shaped shackles 12 if more than one canopy line 5 and/or riser needs to be attached to a connection point 12, as the bow shackle can handle loads at one or more angles offset from the centre line of the looped body.

Alternatively, soft shackles may be used. These are made from rope rather than metal. As a result, they are much lighter and more flexible than metal shackles, while still retaining a high breaking strength.

The canopy 4 has an aerofoil cross section, so it experiences greater lift proximate the leading edge 10A than it does proximate the trailing edge 10B. Each D-shaped shackle 14 may have a load rating, where the greater the thickness of the looped body of each D-shaped shackle 14, the greater the maximum load said D-shaped shackle 14 can withstand without failure. The thickness of the looped body of each D-shaped shackle 14 therefore decreases from the D-shaped shackle 14a proximate the front of the yoke 6 in use to the D-shaped shackle 14c proximate the back of the yoke 6 in use, as the lift exerted on each D-shaped shackle 14 decreases from the D-shaped shackle 14a with canopy lines 5 attached proximate the leading edge 10A of the canopy 4 (the B lines), to the D-shaped shackle 14c with the canopy lines 5 attached proximate the trailing edge 10B of the canopy 4 (the D lines).

Reducing the unnecessary weight in this way is advantageous when designing an aerial vehicle 3 as it helps to minimise fuel consumption and costs. In a similar manner, the thickness of the load pin of each D-shaped shackle 14 may also decrease from the front to the back of the yoke 6 in use, to minimise weight. The diameter of each bore 12 on the yoke 6 may therefore decrease from the front to the back of the yoke 6 in use so that only one load pin can fit exclusively into said bore 12. In other words, the diameter of each bore 12 may be proportional in size to the thickness of the looped body, and/or the thickness of the load pin, of the D-shaped shackle 14 that fits exclusively into said predetermined bore 12. This minimises human error by visually guiding an technician, with little prior knowledge of attaching the canopy 4 to the yoke 6, to insert a D-shaped shackle 14 with a thicker load pin and looped body into the larger one of the at least two bores 12 in the yoke 6.

In at least one embodiment, each of the at least two connection points 12 may further comprise a bushing 15 with a flange 16 at each end. Each bushing 15 may be configured to fit exclusively into a predetermined one of the at least two bores 12 in the yoke 6. The bushing 15 is configured to support the load pin of the D-shaped shackle 14 that is inserted into it. The bushing 15 may be configured to reinforce the bore 12 to prevent tear-out failure. The bushing 15 may prevent metal-on-metal contact of the load pin and the yoke 6, thereby reducing the risk of fretting. The bushing may be configured to provide a high friction interface to ensure the load pin does not rotate inside the bore 12.

In a similar manner to the thickness of each load pin and the thickness of each looped body, the length and/or the diameter of the bushing 15 may be proportional to the diameter of the predetermined one of the at least two bores 12 that the D-shaped shackle 14 fits exclusively into.

As the thickness of the looped body of each D-shaped shackle 14 increases, the distance between the opposing ends of each looped body may increase. As a result, the length of the bushing 15 that each D-shaped shackle 14 fits exclusively into may be proportional to the distance between the two opposing ends of the looped body of said D-shaped shackle 14. In other words, the length of each bushing 15 may increase as the distance between the two opposing ends of each D-shaped shackle 14 increases. The yoke appears transparent in FIG. 3 for reference only, so that the bushing inserted into each connection point can be seen. FIG. 3 shows the length of each bushing 15 increasing from the back to the front of the yoke 6 in use. This ensures that each flange 16 of each bushing 15 may sit substantially flush with one of the two opposing ends of the looped body of said D-shaped shackle 14. This makes it more intuitive for a technician with little prior knowledge of the setup to insert the correct D-shaped shackle 14 into a predetermined one of the at least two bores 12 in the yoke 6.

In another embodiment, two bushings 15 may be inserted into each bore 12 instead of one, for ease of assembly. The first bushing 15 may be inserted into one of the at least two bores 12 on a first side of the yoke 6, and the second bushing 15 may be inserted into said bore 12 on a second side of the yoke 6. Each bushing 15 may comprise a flange 16 on one side; namely the side that faces outward from the yoke 6 when inserted into one of the at least two bores 12.

Alternatively, a grommet may be inserted into each bore 12 instead of one or more bushings 15. The grommet comprises a collar on each side, which is comparable to the flange 16 on the bushing 15 in the previous embodiment. The grommet may be made from rubber to provide a flexible, high friction interface with the load pin.

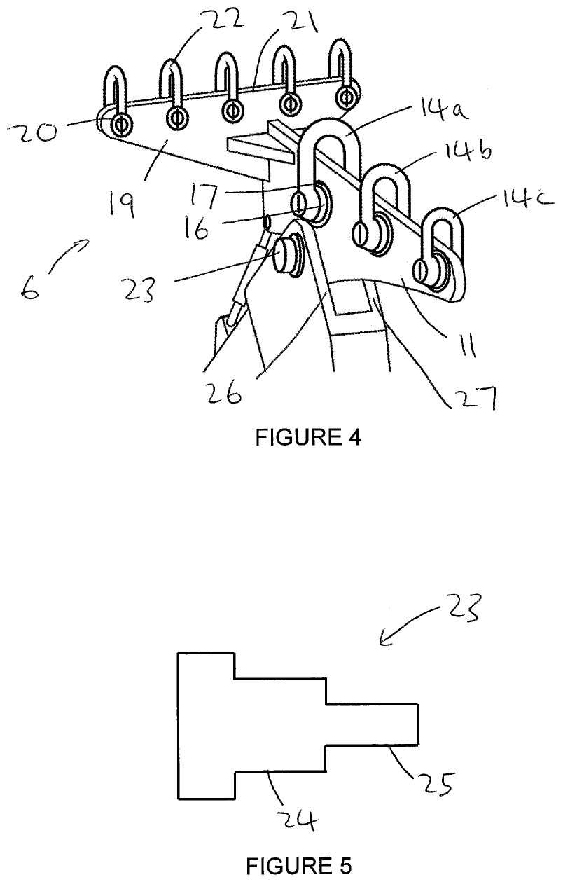

Referring now to FIG. 4, each of the three connection points 12 may further comprise a first boss 17 and a second boss 18 (indicated in FIG. 3), where the first boss 17 is configured to extend outward from a first side of each bore 12 on a first side of the yoke 6 and the second boss 18 is configured to extend outward from a second side of each bore 12 on a second side of the yoke 6, in the opposite direction to the first boss 17.

Each boss 17 comprises a raised protrusion around the perimeter of the first or second side of each bore 12. Each boss 17,18 is configured to extend out from the plane of the yoke 6. It prevents tear-out failure by providing a flat surface for a flange 16 of a given bushing 15 to sit flush with when fitted into a given bore 12. For each bushing 15, each flange 16 comprises a first face and a second face. When said bushing 15 is inserted into one of the at least two bores 12 in the yoke 6, the first face of said flange 16 is configured to face away from a first side of the yoke 6 and sit flush with one of the two opposing ends of the looped body of the D-shaped shackle 14 that fits exclusively into said one of the at least two bores 12. The second face of said flange 16 is configured to face towards the yoke 6 and sit flush with the first boss 17 extending out from said bore 12. As shown in FIG. 3, this configuration is mirrored on the second side of the yoke 6 with the second boss 18 extending out from said bore 12, and the other one of the two opposing ends of the looped body of said D-shaped shackle 14.

The distance each first and second boss 17, 18 is configured to extend out from the yoke 6 (in opposite directions) should be proportional to the length of the bushing 15 that fits exclusively into said bore 12, so that each boss 17,18 may sit flush with the second face of each flange 16 of said bushing 15. As the length of the bushing 15 decreases from the front of the yoke 6 to the back of the yoke 6 in use, the distance the first and second bosses 17,18 extend out from the yoke 6 decreases in proportion.

The addition of a first and second boss 17,18 around each of the at least two bores 12 in the yoke 6 also prevents the one of the at least two D-shaped shackles 14 with the looped body of smallest thickness from being installed into the one of the at least two bores 12 with the larger diameter. The distance between the two opposing ends of said D-shaped shackle 14 with the smallest thickness would be too small for the first face of the flange 16 of the bushing 15 to sit flush with one of the opposing ends of said D-shackle 14, the second face of the flange 16 to sit flush with the boss 17, 18, and for this configuration to be mirrored on the second side of the yoke 6.

In other words, the distance between the two opposing ends of the looped body of each D-shaped shackle 14 may be substantially equal to the length of the bushing 15 (including the first and second flange 16 of said bushing 15) that said D-shaped shackle 14 fits exclusively into, plus the total distance the first and second bosses 17,18 are configured to extend out from each side of the yoke 6. This ensures that each D-shaped shackle 14 may be securely supported by the yoke 6. It also prevents, for example, the load pin of the D-shaped shackle 14 with smallest thickness from being incorrectly installed into the one bore 12 with the largest diameter, as the distance between the two opposing ends of the looped body of said D-shaped shackle 14 would be smaller than the length of the bushing 15 that fits into said bore 12 with the largest diameter, plus the total distance the first and second bosses 17, 18 around said bore 12 are configured to extend out from either side of the yoke 6.

The load pin of the D-shaped shackle 14 with the largest thickness will not fit into the bore 12 with the smallest diameter, for at least the reason that the diameter of said bore 12 is smaller than the thickness of said load pin.

Referring to FIG. 2, the diameter of the three bores 12 on the primary plate 11 of the yoke 6 may decrease from the front to the back of the yoke 6 in use. As the length of each bushing 15 that fits into one of the three bores 12 is proportional to the diameter of said bores 12, no two bushings 15 have the same length. As a result, the technician will only be able to exclusively fit one of the three D-shaped shackles 14 into a predetermined one of the three bores 12, such that the canopy line system 5 may be securable to the yoke 6 in one orientation only. This eliminates any human error.

In an alternative embodiment, the at least two connection points 12 may each comprise a pin, instead of a bore 12, that extends out from the yoke 6. The at least two connectors 14 may then each comprise a ring connector, instead of a D-shaped shackle 14, configured to loop around each pin. Each ring connector and pin may be sized such that only one of the at least two ring connectors may fit exclusively around a predetermined one of the at least two pins. Other connector-connection point mechanisms may be implemented instead such as brackets for the connection points 14, which may be welded or bolted onto a top face of the yoke 6 in use such that the canopy lines 5 are configured to loop through the brackets.

In another embodiment, the at least two connection points 12 and the at least two connectors 14 may both be configured in shape such that each of the at least two connectors 14 fit exclusively into a predetermined one of the at least two connection points 12 in the yoke 6. In other words, instead of the diameter of the at least two bores 12 varying as in FIG. 2, the shape of the at least two bores 12 varies. Alternatively, the shape and the size of the at least two bores 12 may both be configured to vary.

The at least two connection points 12 may comprise a first connection point and a second connection point, wherein the first connection point comprises a square hole in the yoke 6, and the second connection point comprises a round hole in the yoke. 6 The at least two holes are not limited to these shapes. For example, one hole may be triangular.

The at least two connectors 14 may comprise a first connector and a second connector. The first connector may comprise a square cross-section to fit exclusively into the first connection point which comprises a square hole. The second connector may comprise a circular cross-section to fit exclusively into the second connection point which has a round hole. It would be obvious to a technician not to fit a connector with a circular cross-section into a connection point with a square hole.

In another embodiment, instead of the size or shape of the at least two connection points 12 varying across the yoke 6, the at least two connection points 12 may be positioned on the yoke 6 such that each of the at least two connectors 14 fit exclusively into a predetermined one of the at least two connection points 12 in the yoke 6. Alternatively, any combination of varying size, shape and/or positioning of the at least two connection points 12 on the yoke 6 may be used.

As the thickness of the looped body of each D-shaped shackle 14 decreases from the front to the back of the yoke 6 in use, the height of each D-shaped shackle 14 may decrease in proportion. As shown in FIGS. 3 and 4, the distance between the centre of each of the at least two bores 12 and the top edge 13 of the primary plate 11 of the yoke 6 in use may therefore have to decrease in proportion to the thickness of the looped body of the D-shaped shackle 14 that fits exclusively into said predetermined bore 12.

This is to ensure that the B, C and D canopy lines can be attached to the D-shaped shackles 14 in a substantially straight line relative to the top edge 13 of the primary plate 11 of the yoke 6. If the centre of the three bores 12 were at an equal distance from the top edge 13 of the primary plate 11, the D-shaped shackle 14 inserted into the bore 12 at the front of the primary plate 11 in use would be at a greater height above the top edge 13 of the primary plate 11 in use than the D-shaped shackle 14 inserted into the bore 12 at the back of the primary plate 11 in use. This is because the height of the D-shaped shackle 14a at the front of the yoke 6 in use is larger than that of the D-shaped shackle 14c at the back of the yoke 6 in use. This may result in the B canopy lines attached to the bore 12 at the front of the primary plate 11 in use going slack, and/or the D canopy lines attached to the bore 12 at the back of the primary plate 11 in use being pulled too taut. The user would then have little control over the canopy 4.

To overcome this, the distance between the centre of each bore 12 and the top edge 13 of the primary plate 11 of the yoke 6 in use may be proportional to the thickness of the looped body of the D-shaped shackle 14 that fits exclusively into said predetermined bore 12. The height of the looped body of each D-shaped shackle 14 may then be configured in size such that said D-shaped shackle 14 fits exclusively into a predetermined one of the at least two connection points 12 in the yoke 6, and the canopy lines 5 are then configured to attach to the D-shaped shackles 14 in a substantially straight line relative to the top edge 13 of the primary plate 11 of the yoke 6 in use.

As disclosed in the embodiment in FIG. 4, the yoke 6 may further comprise a secondary plate 19 arranged perpendicular to the primary plate 11. In use, the secondary plate 19 is substantially perpendicular to the longitudinal axis of the vehicle 3. The plane of the secondary plate 19 may be vertically arranged in use. The secondary plate 19 may be substantially elongate.

The secondary plate 19 may comprise at least two connection points 20 located along a top edge 21 of the secondary plate 19 and spaced apart from each other in a direction substantially perpendicular to the longitudinal axis of the vehicle 3 in use. This ensures a stable aerial vehicle 3 as the A canopy lines may be configured to attach to the at least two connection points 20. The at least two connection points 20 may be configured in any combination of size, shape and/or positioning, in a similar way to the at least two connection points 12 on the primary plate 11 of the yoke 6, such that each of the A canopy lines may have a connector 22 that fits exclusively into a predetermined one of the at least two connection points 20 in the secondary plate 19 of the yoke 6. Alternatively, the at least two connection points 20 may be substantially the same in configuration.

The yoke 6 may be configured to be pivotably securable to the vehicle 3 in use. This arrangement provides an alternative configuration for the canopy attachment assembly 2 to be removed from the vehicle 3. The canopy lines 5 may remain attached to the yoke 6 while the canopy attachment assembly 2 is removed as a whole, via a mounting bolt 23 in the yoke 6. The canopy lines 5 may still be removed from the yoke 6. An alternative conventional securing mechanism may be used instead of a mounting bolt 23, such as a screw or pin. Removal of the yoke 6 via the mounting bolt 23 avoids the need to remove the canopy lines 5 from the D-shaped shackles 14, thereby reducing/preventing any human error when reattaching the canopy lines 5 to the D-shaped shackles 14.

As schematically illustrated in FIG. 5, the mounting bolt 23 may comprise a body with a first end 24 and a second end 25. The first end 24 may have a larger diameter than the second end 25. The vehicle 3 may then comprise a first and second opposing arm 26, 27 so that the mounting bolt 23 may be securable through the first and second opposing arms and the yoke 6.

Referring to FIG. 4, the first opposing arm 26 may be configured to extend across a first side of the primary plate 11 of the yoke 6 and the second opposing arm 27 may be configured to extend across a second side of the primary plate 11 of the yoke 6. A hole may then be configured to align through each of the opposing arms 26, 27 and the primary plate 11. To prevent the yoke 6 from being secured to the vehicle 3 in the wrong orientation, the yoke 6 may further comprise a first and a second boss around the hole.

The first boss may have a different diameter to the second boss such that the mounting bolt 23 may be configured to fit through each hole in the yoke 6 in one orientation only.

The first boss may be configured to extend outward from a first side of the hole on the first side of the yoke 6, and the second boss may be configured to extend outward from a second side of the hole on the second side of the yoke 6, in the opposite direction to the first boss. The first boss may be configured to have a larger diameter than the second boss. Specifically, the diameter of the first boss may be substantially equal to the first end 24 of the mounting bolt 23, and the diameter of the second boss may be substantially equal to the second end 25 of the mounting bolt 23. The diameter of the first end 24 is therefore too large to fit through the second boss, ensuring that the first end 24 of the mounting bolt 23 fits exclusively into the first boss. In this way, there may only be one possible configuration of the mounting bolt 23 relative to the yoke 6, when assembled. The mounting bolt 23 is therefore configured to secure the yoke 6 to the vehicle 3 in one orientation only, thereby reducing/preventing human error on assembly.

In at least one embodiment, where the canopy attachment assembly 2 comprises at least two yokes 6, the distance between the first opposing arm 26 and the second opposing arm 27 (and therefore the length of the mounting bolts 23) may be different for each one of the at least two yokes 6, thereby preventing the at least two yokes from being fitted to the vehicle 3 in the wrong location.

In at least one embodiment, the yoke 6 may comprise at least one sensor. The at least one sensor may be located on at least one of the primary plate 11, the secondary plate 19 of the yoke 6, and the vehicle 3. The at least one sensor may comprise at least one of a non-contact angular position sensor and a load sensor. As the yoke 6 may pivot relative to the vehicle 3 to counteract any misalignment of the canopy 4 relative to the vehicle 3, the non-contact angular position sensor may be configured to monitor the angle of the yoke 6 with respect to the vehicle 3. This information may then be fed back to the flight control system to correct the angle of the yoke 6 with respect to the vehicle 3, if necessary. The angle of the yoke 6 may be adjusted manually, for example by use of turnbuckles, and/or automatically, by use of a servomechanism and a feedback element built into the flight control system.

The at least one non-contact angular position sensor may be connected to at least one of the connectors 14 to measure the angle of the canopy lines 5 attached to the connector 14. This information may then be fed back to the flight control system to determine the location of the canopy 4 in relation to the vehicle 3.

The load sensor may be configured to monitor the lift force(s) exerted on the yoke 6 by the canopy lines 5. This may give an indication of the load distribution across the yoke 6, and help to correct any errors by responding to anomalous sensor readings during flight.

When used in this specification and claims, the terms “comprises” and “comprising” and variations thereof mean that the specified features, steps or integers are included. The terms are not to be interpreted to exclude the presence of other features, steps or components.

The invention may also broadly consist in the parts, elements, steps, examples and/or features referred to or indicated in the specification individually or collectively in any and all combinations of two or more said parts, elements, steps, examples and/or features. In particular, one or more features in any of the embodiments described herein may be combined with one or more features from any other embodiment(s) described herein.

Protection may be sought for any features disclosed in any one or more published documents referenced herein in combination with the present disclosure.

Although certain example embodiments of the invention have been described, the scope of the appended claims is not intended to be limited solely to these embodiments. The claims are to be construed literally, purposively, and/or to encompass equivalents.

1. A canopy attachment assembly comprising:
at least one yoke, wherein the at least one yoke comprises at least two connection points;
a canopy line system, configured to be securable to the at least one yoke in use via at least two connectors, wherein each of the at least two connectors is configured to fit exclusively into a predetermined one of the at least two connection points in the at least one yoke, such that the canopy line system is securable to the at least one yoke in one orientation only.

2. The canopy attachment assembly of claim 1, wherein the at least two connection points and the at least two connectors are configured in size such that each of the at least two connectors fits exclusively into a predetermined one of the at least two connection points in the at least one yoke.

3. The canopy attachment assembly of claim 1, wherein each of the at least two connection points comprises a bore in the at least one yoke.

4. The canopy attachment assembly of claim 1, wherein:
each of the at least two connectors comprises a D-shaped shackle, said D-shaped shackle comprising a looped body and a load pin, the looped body comprising two opposing ends; and
each of the opposing ends comprises an aperture such that the load pin is securable through both apertures in use to form a closed loop.

5. (canceled)

6. The canopy attachment assembly of claim 4, wherein:
each of the at least two connection points comprises a bore in the at least one yoke; and
a diameter of each of the bores is proportional in size to a thickness of the looped body of the D-shaped shackle that fits exclusively into said bore.

7. The canopy attachment assembly of claim 4, wherein:
each of the at least two connection points comprises a bore in the at least one yoke; and
a thickness of the load pin of each D-shaped shackle is proportional in size to a diameter of a predetermined one of the at least two bores that said D-shaped shackle fits exclusively into.

8. The canopy attachment assembly of claim 4, wherein:
each of the at least two connection points comprises a bore in the at least one yoke;
each of the at least two connection points further comprises a bushing with a flange at each end, wherein each of the bushings is configured to fit exclusively into a predetermined one of the at least two bores in the at least one yoke; and
a distance between the two opposing ends of the looped body of each of the D-shaped shackles is proportional to a length of the bushing that said D-shaped shackle fits exclusively into, such that each flange of each bushing is configured to sit substantially flush with one of the two opposing ends of the looped body of said D-shaped shackle.

9. (canceled)

10. The canopy attachment assembly of claim 8, wherein each of the at least two connection points further comprises a first boss and a second boss, the first boss being configured to extend outward from a first side of each a corresponding one of the bores in the at least one yoke and the second boss being configured to extend outward from a second side of a corresponding one of the bores in the at least one yoke in an opposite direction to the first boss, the distance the first and second bosses are configured to extend outward from the at least one yoke proportional to the length of the bushing that fits exclusively into said bore.

11. The canopy attachment assembly of claim 1, wherein:
the at least two connection points and the at least two connectors are both configured in shape such that each of the at least two connectors fits exclusively into a predetermined one of the at least two connection points in the at least one yoke; and
the at least two connection points comprise a first connection point and a second connection point, wherein the first connection point comprises a square hole in the at least one yoke, and the second connection point comprises a round hole in the at least one yoke.

12. (canceled)

13. The canopy attachment assembly of claim 11, wherein the at least two connectors comprise a first connector and a second connector, wherein the first connector comprises a square cross-section to fit exclusively into the first connection point, and the second connector comprises a circular cross-section to fit exclusively into the second connection point.

14. The canopy attachment assembly of claim 1, wherein the at least two connection points are positioned on the at least one yoke such that each of the at least two connectors fits exclusively into a predetermined one of the at least two connection points in the at least one yoke.

15. The canopy attachment assembly of claim 1, wherein:
the at least one yoke comprises a primary plate, a plane of the primary plate being vertically arranged in use; and
the at least two connection points are located proximate a top edge of the primary plate of the at least one yoke in use.

16. (canceled)

17. The canopy attachment assembly of claim 15, wherein:
each of the at least two connection points comprises a bore in the at least one yoke;
each of the at least two connectors comprises a D-shaped shackle, said D-shaped shackle comprising a looped body; and
for each of the bores, a distance between a centre of the bore and the top edge of the primary plate of the at least one yoke in use is proportional to a thickness of the looped body of the D-shaped shackle that fits exclusively into said bore.

18. The canopy attachment assembly of claim 17, wherein a height of the looped body of each D-shaped shackle is configured in size such that said D-shaped shackle fits exclusively into a predetermined one of the at least two connection points in the at least one yoke.

19. The canopy attachment assembly of claim 1, wherein the at least one yoke comprises a primary plate comprising at least three connection points, the at least three connection points all being substantially collinear.

20. The canopy attachment assembly of claim 15, wherein the at least one yoke further comprises a secondary plate arranged perpendicular to the primary plate.

21. A canopy arrangement comprising:
a canopy attachment assembly according to claim 1; and
a vehicle, wherein the at least one yoke is configured to be pivotably securable to the vehicle in use.

22. The canopy arrangement of claim 21, wherein the at least one yoke is configured to be pivotably securable to the vehicle in use by a mounting bolt.

23. The canopy arrangement of claim 22, wherein the vehicle comprises a first and a second opposing arm, the first opposing arm configured to extend across a first side of a primary plate of the at least one yoke and the second opposing arm configured to extend across a second side of the primary plate of the at least one yoke, wherein a hole is configured to align through each of the opposing arms and the primary plate, the hole through the at least one yoke comprising a first and second boss, the first boss configured to extend outward from a first side of the hole and the second boss configured to extend outward from a second side of the hole in the opposite direction to the first boss, the first boss configured to have a larger diameter than the second boss, such that the mounting bolt is configured to fit through each hole in one orientation only.

24. The canopy attachment assembly of claim 1, wherein the at least one yoke comprises at least one sensor, said at least one sensor comprising at least one of:
a non-contact angular position sensor configured to monitor the angle of the at least one yoke with respect to a vehicle; and
a load sensor configured to monitor a lift force exerted on the at least one yoke.

25. (canceled)
